(19) United States
(12) Patent Application Publication
(10) Pub. No.: US 2026/0234477 A1
(43) Pub. Date: Aug. 13, 2026

(54) A WASTE CONVERSION METHOD

(71) Applicant: CYCLION HOLDINGS PTY LTD, Brisbane (AU)

(72) Inventor: Philip MAJOR, Brisbane (AU)

(21) Appl. No.: 19/156,289

(22) PCT Filed: Feb. 16, 2024
(86) PCT No.: PCT/AU2024/050107

§ 371 Date: Aug. 13, 2025

(30) Foreign Application Priority Data
Feb. 17, 2023 (AU) 2023900407

(51) Int. Cl. C10G 1/08; B01D 53/84; B01J 23/72; B01J 31/02

(52) U.S. Cl. CPC C10G 1/086; B01D 53/84; B01J 23/72; B01J 31/0298; C10G 1/083; B01D 2251/95; B01D 2257/502; B01D 2257/504; B01D 2258/02; C10G 2300/1003; C10G 2300/1011

(57) ABSTRACT

The method including the steps of introducing a waste feed material to a reaction vessel, wherein at least a portion of the waste feed material comprises organic material: processing the waste feed material in the reaction vessel at an elevated temperature in the presence of a catalyst to convert the organic material to one or more hydrocarbon compounds; and removing the one or more by hydrogen compounds from the reaction vessel for use or for further processing.

### TECHNICAL FIELD

The present invention relates to a waste conversion method. In particular, the present invention relates to a waste conversion method for the conversion of organic waste material to energy.

### BACKGROUND

For many years, alternative sources of hydrocarbon fuels to those produced from crude oil have been sought. The use of catalytic depolymerisation to convert hydrocarbon waste materials to hydrocarbon fuels has been put forward as one such alternative.

In a catalytic depolymerisation process (CDP), heat and catalysts are used to convert biomass and mineral based products (such as plastics) to a hydrocarbon fuel, such as diesel. However, existing CDP technology requires extensive pretreatment of waste to minimise particle size via mechanical force. The required equipment such as shredders and disintegrators are energy intensive and costly to maintain and replace. In addition, existing CDP technology is commonly prone to blockage and small dosing rates resulting in frequent interruptions in the production of hydrocarbon fuels. Further, other competing technologies typically require the use of significantly elevated temperatures (in the order of greater than 450° C.) and pressures (typically, greater than atmospheric pressure) which are expensive to maintain and require the use of specialized equipment.

Some attempts to overcome these issues have been made. For instance, PCT application no. PCT/AU2017/000137 describes a CDP process for generating diesel from waste material. However, in this process feed material is separated, based on the nature of the feed material, into separate waste streams which must be treated separately and subsequently recombined prior to being used in a CDP process.

The separation and treatment (including size reduction) of separate feed material streams is a labour, time and energy intensive process. In addition, the separation of feed materials is inaccurate when waste comprising two materials (such as polymer-coated electrical wiring) is present. While the product produced by the process of PCT/AU2017/000137 may be of improved quality over more conventional CDP processes, the process itself is complex, time-consuming, inaccurate and expensive.

Thus, there would be an advantage if it were possible to provide a method for converting waste material into energy that was efficient, non-discriminatory to waste material composition, cost-effective and relatively fast.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a waste conversion method, which may at least partially overcome at least one of the abovementioned disadvantages or provide the consumer with a useful or commercial choice.

With the foregoing in view, the present invention resides broadly in a method for the conversion of waste, the method comprising the steps of:
Introducing a waste feed material to a reaction vessel, wherein at least a portion of the waste feed material comprises organic material, the organic material comprising a biomass portion and/or a polymeric portion;
Processing the waste feed material in the reaction vessel at an elevated temperature in the presence of a medium including one or more ionic liquids, and/or one or more catalysts, and/or one or more solvents, the medium being configured to convert the organic material to one or more hydrocarbon compounds; and
Removing the one or more hydrocarbon compounds from the reaction vessel for use or for further processing.

The waste feed material may be of any suitable form. The waste forming the waste feed material may originate from a single source or may originate from a plurality of sources. In embodiments of the invention in which the waste originates from a plurality of sources, the waste may be combined at the location where the method of the present invention is performed, or may be combined at a location remote to the location at which the method is performed. In this embodiment, the waste may be provided at the location where the method is performed in the form of the waste feed material.

At least a portion of the waste feed material may be received at the location where the method of the present invention is performed in receptacles. Any suitable receptacles may be used, such as bags, sacks, boxes, containers, drums or the like. In some embodiments, such as when the waste material is received in bags, sacks and boxes, the waste material may be introduced to the method without opening the receptacle, as the receptacle may also be processed by the method of the present invention. However, in some embodiments it may be beneficial to open the receptacles to ensure that no harmful or hazardous material (such as, for instance, batteries, asbestos or the like) is introduced to the method. The receptacles may be opened manually, or may be opened using one or more machines. Similarly, any harmful or hazardous material may be removed from the exposed waste material manually, or with one or more machines (such as a robotic arm or the like).

The waste may be sourced from any suitable source. For instance, the waste may be sourced from agricultural, residential, commercial, construction, or industrial sources, or a combination thereof.

As previously stated, at least a portion of the waste feed material comprises organic material. The organic material may comprise any suitable proportion of the waste feed material. Preferably, however, the organic material comprises at least 1% w/w of the waste feed material. More preferably, the organic material comprises at least 10% w/w of the waste feed material. More preferably, the organic material comprises at least 25% w/w of the waste feed material. More preferably, the organic material comprises at least 50% w/w of the waste feed material.

The organic material may be of any suitable form. Preferably, however, at least a portion of the organic material comprises biomass. The biomass may be of any suitable form, such as, but not limited to, vegetable matter (including fruits, vegetables, pulses, grains, grasses, leaves etc.) or animal matter. The biomass may also comprise timber, paper, cardboard, waste products (such as bagasse), food waste and the like.

In some embodiments, at least a portion of the organic material may comprise polymeric materials, such as plastics (such as, but not limited to, HDPE, PP, PET, PVC or polystyrene), agri-waste plastic, rubber (synthetic and/or natural), or oils (including crude oil) and other materials derived from oil.

In a most preferred embodiment of the invention, the organic material comprises a mixture of biomass and/or polymeric materials. The organic material may be liquid, solid or a combination of both.

It is envisaged that at least a portion of the waste feed material may comprise inorganic material. The inorganic material may comprise materials such as metal, glass, rock or the like. In some embodiments of the invention, the waste feed material may undergo a pre-sorting process. It is envisaged that this pre-sorting process occurs prior to pre-treatment or treatment in order to remove large or dangerous materials and/or items, or materials and/or items that are incompatible with the method of the present invention. These items may include, but are not limited to, asbestos, batteries, explosives, pressurised vessels, radioactive materials, corrosive materials, toxic materials, and/or easily removable inorganic materials such as electrical appliances and the like.

The waste feed material may undergo one or more processing steps prior to processing in the reaction vessel. The one or more processing steps may be of any suitable form, although in one embodiment of the invention, the waste feed material may undergo a dewatering process. It will be understood that, in this context, the term “dewatering” is intended to refer to the at least partial removal of water from the waste feed material, as well as any other liquids that may be present.

The dewatering process may be of any suitable type, and may include heating, drying, evaporation or filtration. In a preferred embodiment, the waste feed material may be heated to remove at least a portion of the water contained therein. The waste feed material may be heated to any suitable temperature in any suitable vessel (such as an oven, furnace or the like) for any suitable period of time. However, it will be understood that the waste feed material should be heated for a sufficient period of time to remove the desired quantity of water therefrom. In a preferred embodiment of the invention, the waste feed material may be heated to a temperature of between about 90° C. and about 110° C. More preferably, the waste feed material may be heated to a temperature of about 100° C. In some embodiments, the waste feed material may be combined with a solvent, and particularly an organic solvent, in order to enhance the dewatering process.

Preferably, the waste feed material will not undergo a specific dewatering process. The waste feed material may be incidentally dewatered during the elevated temperature processing in the reaction vessel to reduce energy expenditure and system costs.

Preferably, the waste feed material may undergo one or more processing steps prior to processing in the reaction vessel. The one or more processing steps may be of any suitable form, although in a preferred embodiment of the invention the waste feed material may be compressed or compacted prior to processing in the reaction vessel. Compressing or compacting the waste feed material may be performed using any suitable technique, such as by using a press, compactor or the like.

The waste feed material may be compressed or compacted to any suitable degree. It is envisaged, however, that the waste feed material will not be compacted to a point where the ionic liquid in the reaction vessel is unable to contact substantially all of the surfaces of the waste within the waste feed material. Instead, it will be understood that the purpose of compressing or compacting the waste feed material may be to increase the quantity of waste that may be processed in a single batch in the reaction vessel and for ease of transport.

In some embodiments, the waste feed material may be compressed for ease and efficiency of transportation to the location at which the method takes place. The compressed waste feed material may then be decompressed prior to being introduced to the reaction vessel.

It will be understood that the one or more processing steps that the waste feed material may undergo prior to processing do not include separating the waste feed material into separate streams based on properties of the waste. Typically, the one or more processing steps will not include subjecting the waste feed material to a particle size reduction process, although it will be understood that some breakage may be required to reduce large pieces of waste in size so that they are capable of being introduced to the reaction vessel. Similarly, if the waste material is too compacted, it may be necessary to break the waste in order to increase the available surface area. However, it will be understood that intensive grinding processes will not be undertaken.

In some embodiments, the particle size of the waste feed material is reduced in an grinding process. Any suitable grinding process may be used, and the grinding process may be an autogenous grinding process, or a grinding medium may be provided. In a preferred embodiment, the particle size of the waste feed material is reduced in a stirred mill. In some embodiments of the invention, agitation of the mill may be achieved using an impeller. In other embodiments, agitation of the mill may be achieved by introducing one or more jets of jets of fluid into the mill, thereby creating rotation of the contents of the mill. Preferably, the one or more jets of fluid may be introduced from inlets provided in a wall of the mill reaction vessel. The inlet fluid provides circulation to generate rotation of the waste feed material to aid in the breakdown of organic matter, providing an increased surface area for the one or more fluids to further interact.

In some embodiments, the waste feed material may be subjected to a classification process before continuing to the compaction process or the reaction vessel. Any suitable classification process may be used, although in a preferred embodiment of the invention, the classification process may involve separating the waste feed material on the basis of particle size. In this embodiment of the invention, the classification process may comprise a screening process. In a particular embodiment, the waste feed material may be introduced to a Trommel screen (or similar rotary screen) to separate materials such as soil, dirt, glass, metal or the like from the waste feed material before the waste feed material continues to the compaction process or the reaction vessel.

The waste feed material may be introduced to the reaction vessel using any suitable technique. For instance, the waste feed material may be introduced to the reaction vessel manually (such as by using hand-held equipment including shovels or the like, or vehicles such as bobcats, loaders, backhoes or he like, or any suitable combination thereof). Alternatively, the waste feed material may be introduced to the reaction vessel using conveyors, augers, feeders (such as vibrating feeders, apron feeders or the like) or similar equipment.

In a preferred embodiment, the method of the present invention is a batch process. Thus, once a predetermined quantity of waste feed material has been introduced to the reaction vessel, the processing of the waste feed material in the reaction vessel may commence.

In a preferred embodiment, the method of the present invention will be a continuous process. It is envisaged that a continuous process may reduce the environmental and/or financial costs, as week as reducing or eliminating adverse effects on process equipment that may arise from regular stopping and starting of the equipment in a batch process. In some embodiments, the reaction vessel may accept a predetermined quantity of waste feed material and begin the liquidation process. As the liquidation process is being undertaken, the liquified waste material may be transferred to one or more secondary reaction vessels to allow more waste feed material to be liquified.

In some embodiments of the invention, the secondary reaction vessels may comprise a plurality of reaction vessels in which one or more reaction vessels may be pressurised to allow continuous filling and transfer of waste feed material and liquified waste feed material.

The predetermined quantity of waste feed material may be in the form of a predetermined volume of the waste feed material or a predetermined mass of the waste feed material. Thus, one or more measurement devices (such as scales or the like) may be provided to determine the predetermined quantity of the waste feed material to be introduced to the reaction vessel.

The reaction vessel may be of any suitable form. For instance, the reaction vessel may be of any suitable size, shape or configuration, and may comprise a tank, reactor or the like. The reaction vessel may be a pressure vessel. Preferably, the reaction vessel is substantially circular in shape to facilitate fluid circulation.

In some embodiments, the reaction vessel may be agitated. Agitation of the reaction vessel may be achieved using any suitable technique, such as one or more impellers, recirculating pumps or the like, or any suitable combination thereof. The reaction vessel may be a pressurised or non-pressurised reactor.

The reaction vessel may be an open vessel or a closed vessel. However, in a preferred embodiment of the invention, the reaction vessel may be a closed vessel with controlled venting procedures to mitigate pressure build up. Any suitable atmosphere may be present in the reaction vessel. In a preferred embodiment of the invention, however, the atmosphere in the reaction vessel is relatively inert. The relatively inert atmosphere may be provided by introducing an inert gas, or mixture of two or more inert gases, to the reaction vessel. Any suitable inert gas may be used, although in one specific example the inert gas may comprise nitrogen. Beneficially, the use of an inert gas as the atmosphere within the reaction vessel may serve to remove oxygen from the reaction vessel, thereby reducing or eliminating the risk of fire or explosion due to the production of volatile gases within the reaction vessel. In addition, the use of an inert atmosphere within the reaction vessel may improve the removal of reactant gases from the vessel.

The reaction vessel may be of any suitable volume, and it will be understood that the exact volume of the reaction vessel will be dependent on the desired throughput for the method and the availability of the waste material. Thus, the volume of the reaction vessel may vary depending on these factors, or may be scaled upwardly or downwardly according to the availability of waste material and so on.

The reaction vessel may be a single reaction vessel, or may comprise a plurality of reaction vessels. Preferably, the plurality of reaction vessels may be in fluid communication with one another. The plurality of reactions vessels may be in fluid communication with one another in any suitable manner. In some embodiments the plurality of reaction vessels will be connected in a recirculation loop.

The recirculation loop may transfer fluid between the plurality of reaction vessels using any suitable technique. In some embodiments the recirculation loop will transfer fluid using a pumping mechanism. Any suitable pumping device may be used in the pumping mechanism, although in some embodiments the plurality of reaction vessels will be connected using an in-line pump and/or mixing device.

The plurality of reaction vessels may require one or more heat and/or heat recovery treatments. In some embodiments, the plurality of reaction vessels may transfer heat between reaction vessels to heat and/or cool separate reaction vessels. This may be achieved using any suitable technique. For instance, heated liquid may be transferred between reaction vessels, and the heat may be recovered from the heated liquid. In other embodiments, one or more heat exchange devices may be used to heat and/or cool fluid transferred between reaction vessels.

The waste feed material may comprise solids, liquids or a combination of the two. In some embodiments, the reaction vessel may contain a delivery mechanism for introducing the waste feed material into the reaction vessel. Any suitable delivery mechanism may be provided, such as a conveyor, feed chute, hopper or the like. In some embodiments, the delivery mechanism may comprise a container configured to hold at least a portion of the waste feed material and introduce it to the reaction vessel. Thus, the delivery mechanism may comprise a basket, bucket, bag, net or the like, or a combination thereof.

In some embodiments of the invention, the reaction vessel may comprise a plurality of one or more relatively small reaction vessels. In this embodiment, it is envisaged that providing a plurality of relatively small reaction vessels may reduce operating and capital costs in comparison to relatively large reaction vessels.

The processing of the waste feed material in the reaction vessel may be of any suitable form. Preferably, however, the waste feed material (or at least the organic portion thereof) may be converted to one or more hydrocarbon compounds using any suitable technique. Preferably, the conversion of the waste feed material (or at least the organic portion thereof) may be achieved through the solubilisation such that at least the organic portion of the waste feed material may be broken down to a liquid and/or gas. In one embodiment, the organic portion of the waste feed material may be subject to chemical decomposition and/or depolymerisation within the reaction vessel.

Preferably, the solubilisation of at least the organic portion of the waste feed material may be achieved through a combination of the presence of the catalyst and the elevated temperature of the reaction vessel.

It will be understood that the decomposition, depolymerisation and/or solubilisation of the organic portion of the waste feed material may result in the production of hydrocarbons. Any suitable hydrocarbons may be produced, and it is envisaged that the hydrocarbons may comprise saturated hydrocarbons, unsaturated hydrocarbons, aromatic hydrocarbons, or a mixture thereof. In a preferred embodiment, the hydrocarbons may be saturated hydrocarbons and, in particular, alkanes.

In some embodiments of the invention a portion of the organic portion of the waste feed material may not be converted into hydrocarbons. In these embodiments, a residual or unconverted organic portion of the waste feed material may be liquified and transferred to a separation and/or refining vessel.

The separation and/or refining vessel may be optionally pressurised.

In some embodiments of the present invention, the first reaction vessel may be at atmospheric pressure, and the separation and/or refining vessel may be pressurised to any suitable pressure to complete the depolymerisation process. In some embodiments the pressure of the separation and/or refining vessel may be between 60-80 bar, more preferably the pressure of the separation and/or refining vessel may be between 50-70 bar, most preferably the pressure of the separation and/or refining vessel may be between 30-50 bar.

The separation and/or refining vessel will typically be maintained at relatively low temperatures. In particular, it is envisaged that the separation and/or refining vessel may be maintained at a temperature of below approximately 310° C.

In some embodiments the separation and/or refining vessel may comprise, or be associated with, a distillation column.

It is envisaged that the separation and/or refining vessel may be provided with one or more catalysts. The one or more catalysts may be of any suitable form. In some embodiments of the invention, the catalyst may be in a solid state, such as, but not limited to a powdered substance. It is envisaged that the solid state catalysts may aid in catalyst recovery and recycling.

In some embodiments of the invention, the catalyst may comprise a catalyst on a solid support, such as, but not limited to extrusions or beads. It is envisaged that the solid state supported catalysts may also provide a means to reuse the catalyst.

In some embodiments of the invention, the conversion process may comprise one or more different catalyst forms at different reaction steps. In a preferred embodiment of the invention, a first reaction vessel may comprise a liquid catalyst to prevent equipment blockages and eliminate a separation step, and a second reaction vessel may comprise an immobilised solid catalyst.

In a specific embodiment of the invention, the second reaction vessel may comprise an immobilised solid catalyst in a packed bed arrangement to allow for catalyst reuse without the need for a separation process.

In a specific embodiment, the one or more catalysts may comprise Cu/TiO₂. Other examples of the one or more catalysts may include zeolite (and, specifically, type A sodium aluminosilicate, 2Na₂O·2Al₂O₃·4SiO₂·9H₂O), homogenous or heterogenous organometallic catalysts for tandem dehydrogenation (such as, but not limited to SnPt/y-Al₂O₃), olefin metathesis catalysts (such as, but not limited to, WOₓ/SiO₂) and the like, or any suitable combination thereof.

The separation and/or refining vessel may also be provided with one or more solvents. The one or more solvents may be of any suitable form, although it is envisaged that the one or more solvents may be added to the reaction vessel to assist in solubilising the organic portion of the waste feed stream.

In some embodiments of the invention, a medium may be provided within the reaction vessel. The medium may be of any suitable form, although in some embodiments the medium may comprise one or more ionic liquids, a plurality of nanoparticles or a combination of the two. In this embodiment, the one or more ionic liquids may also comprise the catalyst. Any suitable ionic liquid may be used, although it is envisaged that the ionic liquid may comprise a liquid salt. In a preferred embodiment, the ionic liquid comprises a liquid organic salt. In some embodiments, a single ionic liquid may be used to decompose and/or depolymerise substantially all the organic material in the waste feed material. In a particular embodiment of the invention, the medium may comprise a nano catalyst treatment fluid (NCTF).

Preferably, the medium may comprise two or more ionic liquids, a plurality of nanoparticles and/or one or more additional catalysts. In these embodiments of the invention, it will be understood that different ionic liquids in the medium may assist in the decomposition and/or depolymerisation of different components of the organic material in the waste feed material. For instance, one or more ionic liquids may be present to aid in the decomposition and/or depolymerisation of the biomass portion of the organic material, while one or more different ionic liquids may be present to aid in the decomposition and/or depolymerisation of the polymeric portion of the organic material.

Preferably, the ionic liquid may include methylimidazolium and/or pyridinium ions. One specific example of a suitable ionic liquid may be 1-butyl-3-methylimidazolium chloride-aluminium chloride. Other ionic liquids may include [Benz-SO₃Him]+ with any suitable counterion such as, but not limited to, [H₂PO₄]⁻; [HSO₄]⁻; [TsO]⁻0 and/or [TfO]⁻.

In some embodiments the one or more ionic liquids may include BuPy Cl/AlC₃, [Bmim][Cl/AlCl₃], (mSiO₂/Pt/SiO₂), [C₄Py]Cl—AlCl₃, SnPt/y-Al₂O₃, WOₓ/SiO₂, [P14,6,6,6]⁺, CaMTC16, H-DBN Cl/ZnCl2, and/or NEt₃ AlCl₄.

It is envisaged that the ionic liquid may also act as a solvent. Thus, in a specific embodiment of the invention, it is envisaged that the ionic liquid (or mixture of ionic liquids) may comprise the totality of the medium within the reaction vessel, and may function as both solvent and catalyst.

In an alternative embodiment of the invention, the medium may further comprise one or more solvents. The one or more solvents may be of any suitable form, although it is envisaged that the one or more solvents may be added to the reaction vessel to assist in solubilising the organic portion of the waste feed stream.

Any suitable solvent may be used, although in a preferred embodiment of the invention the solvent is a polar organic solvent.

The polar organic solvents may include, but are not limited to, dimethyl sulfoxide (DMSO), n-pentane and/or glycerol.

In some embodiments the polar organic solvent may comprise glycerol. In a preferred embodiment, the glycerol is crude glycerol.

In some embodiments the organic solvent may comprise a crude solvent product, such as, but not limited to crude diesel, petroleum, biodiesel, fractionated oils, or kerosene.

It is envisaged that, in some embodiments of the invention, the solvent may also act as the catalyst.

In some embodiments of the invention, the ionic liquid may function as a first solvent and one or more additional solvents (such as, but not limited to, DMSO, n-pentane or glycerol) may be added to the reaction vessel.

Preferably, the one or more additional solvents may be configured to separate the ionic liquid from the decomposed and/or depolymerised organic material.

As previously stated, the one or more ionic liquids may comprise catalysts. In other embodiments, one or more catalysts may be added to the medium. The one or more catalysts may be additional to the catalytic properties of the one or more ionic liquids. Alternatively, if the one or more ionic liquids have no catalytic function, the one or more catalysts may comprise the only catalysts in the medium.

The one or more catalysts may be of any suitable form. A specific example of the one or more catalyst is Cu/TiO₂. Other examples of the one or more catalysts may include zeolite (and, specifically, type A sodium aluminosilicate, 2Na₂O·2Al₂O₃·4SiO₂·9H₂O), homogenous or heterogenous organometallic catalysts for tandem dehydrogenation (such as, but not limited to SnPt/y-Al₂O₃), olefin metathesis catalysts (such as, but not limited to, WOₓ/SiO₂) and the like, or any suitable combination thereof.

In some embodiments, the one or more catalysts may comprise a naturally occurring material such as a diatomaceous earth material or a clay. Any suitable form of clay may be used, although in a preferred embodiment, the clay may comprise a modified clay. For instance, the modified clay may comprise an ionic liquid-modified clay, such as, but not limited to CaMTC16. It is envisaged that the modified clay may be modified to provide active surface moieties. Preferably the active surface moieties may be configured to catalyse a reaction, absorb one or more molecules or the like, or a combination thereof.

The clay may be of any suitable form. For instance, the clay may be a modified clay such as, but not limited to, calcium rich montmorillonite (CaMT) and an alkyl chain. In a preferred embodiment, the modified clay may be an ionic liquid-modified clay, such as CaMTC16. It is envisaged that the modified clay may be modified to provide active surface moieties. Preferably the active surface moieties may be configured to catalyse a reaction, absorb one or more molecules or the like, or a combination thereof.

In some embodiments, the medium may include a plurality of nanoparticles. Any suitable nanoparticles may be used, although it is envisaged that the nanoparticles may include nanoparticles of tungsten, disulfidezinc oxide, silicon dioxide, diamond, clay, boron, boron nitride, silver, titanium dioxide, tungsten, y-aluminium oxide, carbon or molybdenum disulfide.

The nanoparticles may be of any suitable particle size. Preferably, the nanoparticles have a particle size of less than 10 nm, and preferably the nanoparticles have at least one dimension ranging from 1-100 nm in size.

It is envisaged that the presence of nanoparticles in the medium may assist in reducing odours and suppressing dust and other aerosols when mixed with the waste feed material at relatively low temperatures. In addition, the nanoparticles may also assist in reducing or eliminating deactivation of the one or more ionic liquids and/or catalyst.

In some embodiments, the nanoparticles may be condensed in colloidal suspension in the one or more ionic liquids to form a nanofluid. Typically, nanofluids facilitate greater convective heat transfer, viscosity, thermal diffusivity and thermal conductivity in comparison to fluid such as water or oil.

It is envisaged that the medium may comprise a combination of two or more ionic liquids and/or two or more catalysts. This may be necessary to decompose and/or depolymerise different portions of the waste feed material. For instance, a first catalyst and/or a first ionic liquid may be required to decompose and/or depolymerise a biomass portion of the waste feed material, while a second catalyst and/or a second ionic liquid may be required to decompose and/or depolymerise a polymeric portion of the waste feed material.

The relative proportions of the ionic liquids and/or catalysts in the medium may vary depending on the composition of the waste feed material.

It is envisaged that a medium in the form of an NCTF facilitates decomposition and depolymerisation, without the need for significant mechanical separation, high shear, or grinding machinery. This separation and size reduction in conventional processes is energy intensive and costly, and commonly causes significant equipment wear and maintenance issues.

In addition, traditional separation of inorganic components typically produces residues that create problems in downstream equipment, such as pumps. Therefore, the NCTF's not only assist with more thorough removal of inorganics and harmful substances, but also provide a more consistent reaction product generated from the waste feed material.

Further, an NCTF medium may act as an ion exchange material, which may have the effect of retaining heteroatoms such as phosphorus, halogens, chlorine, and heavy metals present in the waste feed material. These heteroatoms may be converted into inorganic salts with specific catalysts and lime. Preferably, any remaining sulfur may be reduced further using a specific NCTF medium. By comparison, the high temperatures of conventional pyrolysis and incineration processes require the scrubbing of gases to prevent the release of highly carcinogenic dioxins and furans. These conventional processes are costly and do not always produce the desired results.

The medium may be of any suitable pH. It is envisaged that the pH of the medium may be acidic or basic. Alternatively, the pH of the medium may be modified depending on the nature of the waste to be treated in the reaction vessel. The pH may be modified in any suitable manner, although in a preferred embodiment of the invention the pH may be modified through the addition of a pH modifying substance to the medium. Any suitable pH modifying substance may be used such as, but not limited to, lime (if a basic pH is desired) or an acid (if an acidic pH is desired).

The pH of the medium may be raised to any suitable pH. For instance, the pH in the reaction vessel may be greater than 7. In other instances, the pH of the vessel may be less than 7. It will be noted, however, that the exact pH in the reaction vessel is not critical, provided that the pH is maintained in the range suitable for the process.

In some embodiments of the invention, the medium comprising one or more ionic liquids may contain nanoparticles. It is envisaged the nanoparticles may be in the form of graphite, carbon nanotubes, mesoporous carbon, and/or boron nitride. In a preferred embodiment, the solution comprises up to 20 wt % nanoparticles. More preferably, the solution comprises up to 10 wt % nanoparticles. Still more preferably, the solution comprises up to 5 wt % nanoparticles. Yet more preferably, the solution comprises up to 3 wt % nanoparticles.

It is envisaged that the addition of nanoparticles to the medium containing one or more ionic liquids may assist in heat dispersion and/or heat transfer. It is also envisaged that the nanoparticles may be used to modify the flashpoint of the solution.

As previously stated, the waste feed material is processed at an elevated temperature within the reaction vessel. Any suitable elevated temperature may be used, and it will be understood that the elevated temperature used may be dependent on the nature of the waste feed material. In a preferred embodiment of the invention, the elevated temperature may be between about 25° C. and about 400° C. More preferably, the elevated temperature may be between about 30° C. and about 310° C. Still more preferably, the elevated temperature may be between about 60° C. and about 220° C.

In a preferred embodiment, the reaction vessel may be heated to a plurality of elevated temperatures in order to process the waste feed material. It is envisaged that different components of the waste feed material may decompose and/or depolymerise at different temperatures. Therefore, heating the reaction vessel to a plurality of different elevated temperatures may ensure that all organic components of the waste feed material are decomposed and/or depolymerised.

In some embodiments of the invention, the temperature of the reaction vessel may be increased substantially continuously over any suitable period of time to an upper elevated temperature. Alternatively, the temperature of the reaction vessel may be raised to a first elevated temperature and held at the first elevated temperature for a period of time. The reaction vessel may then be heated to a second elevated temperature and held at the second elevated temperature for a period of time. This process may be repeated until the upper elevated temperature is reached.

It is envisaged that, depending on the nature of the waste feed material, the temperature of the reaction vessel may be reduced from one elevated temperature to another elevated temperature.

In some embodiments of the invention, the temperature may be adjusted from a first temperature at which the biomass portion of the waste material is decomposed or deconstructed, to a second temperature at which the polymeric portion of the waste material is depolymerised. In these embodiments of the invention, it is envisaged that, in a first stage, the temperature of the reaction vessel may be adjusted to between about 60° C. and 300° C. to decompose or deconstruct the biomass portion of the waste material, after which the temperature of the reaction vessel may be adjusted to between about 100° C. and about 310° C. to depolymerise the polymeric portion of the waste material.

The temperature of the reaction vessel may be raised to the one or more elevated temperatures using any suitable technique. For instance, one or more heat sources (such as burners, heat probes or the like) may be used to maintain the reaction vessel at the elevated temperature. In further embodiments of the invention, the reaction vessel may be provided with a heating and/or cooling system. Any suitable system may be used, although in a particular embodiment of the invention it is envisaged that the reaction vessel may be at least partially surrounded by a jacket through which heating and/or cooling fluid may be circulated to control the temperature within the reaction vessel. Alternatively, heating and/or cooling fluid may be circulated through one or more pipes or jackets located within the reaction vessel to control the temperature therewithin.

In some embodiments of the invention, the temperature of the reaction vessel may be raised to the one or more elevated temperatures using infrared radiation. The infrared radiation may be indirect or direct, but in the preferred embodiment, the temperature of the reaction vessel is raised using direct infrared radiation.

In some embodiments of the invention, the infrared radiation may be a broad-spectrum wavelength. Alternatively, the infrared radiation may be of a targeted wavelength.

In some embodiments of the invention, the reaction vessel temperature may be raised to the one or more elevated temperatures using both infrared radiation and an external heat source (such as a heat exchanger) to enhance the accuracy and/or stability of the temperature control.

The temperature of the reaction vessel may be controlled by varying the wavelength and intensity of the infrared radiation.

In some embodiments of the invention, the biomass portion of the waste feed material is treated using one or more ionic liquids at a first elevated temperature. The one or more ionic liquids may be of any suitable type, although in a preferred embodiment of the invention the one or more ionic liquids may comprise BuPy Cl/AlCl₃, [Bmim][Cl/AlCl₃], (mSiO₂/Pt/SiO₂), [C₄Py]Cl/Al—Cl₃, SnPt/y-Al₂O₃, WOₓ/SiO₂, [P14,6,6,6]⁺, CaMTC16, H-DBN Cl/ZnCl2, and/or NEt₃ AlCl₄.

It is envisaged that the first treatment step may remove substantially all the biomass present in the waste feed stock. The biomass may be removed using any suitable technique, although in a preferred embodiment the biomass may be digested, decomposed and/or disintegrated, although it will be understood that the purpose of the first treatment step is to generate hydrocarbons from the biomass.

Preferably, following the removal of the biomass portion of the waste feed material, a subsequent treatment step may be configured treat the plastic component of the waste feed material. It is envisaged that the one or more ionic liquids would be configured to treat the remaining waste feed material at a second elevated temperature. Any suitable treatment may be used, although in a preferred embodiment the remaining waste feed material may be treated to remove the polymer portion therefrom. The polymer portion may be removed using any suitable technique, although in a preferred embodiment the polymer portion may be digested, decomposed and/or disintegrated, although it will be understood that the purpose of the second treatment step is to generate hydrocarbons from the polymer portion.

In a preferred embodiment, the one or more catalysts may be chosen to treat both the biomass portion and the polymer portion of the waste feed material without the need for subsequent treatment steps.

In some embodiments of the invention, a third treatment step may be performed to complete the separation of the hydrocarbons from the waste feed material. Preferably, the third treatment step involves the removal of the hydrocarbons generated by the treatment of the biomass potion and the polymer portion of the waste feed material from the reaction vessel.

The total residence time for the treatment of the waste feed material may vary depending on the composition and particle size of the waste feed material. Any suitable residence time may be used, and it will be understood that the time taken may be dependent on the nature of the waste feed material. In a preferred embodiment of the invention, the residence time may be between about 3 hours and about 8 hours. More preferably, the residence time may be between about 2 hours and about 6 hours. Still more preferably, the elevated temperature may be between about 1 hour and about 4 hours.

In some embodiments of the invention, the solubilisation of the organic portion of the waste feed material may result in the generation of sulfur and/or chlorine (or compounds thereof). In a preferred embodiment of the invention, sulfur and chlorine generated in the reaction vessel may be removed separately to the hydrocarbons.

The sulfur and/or chlorine may be removed from the reaction vessel using any suitable technique. For instance, the sulfur and chlorine generated in the reaction vessel may be captured or sequestered using zeolite and lime, and/or one or more ionic liquids.

Alternatively, the sulfur and chlorine generated in the reaction vessel may be condensed and treated with one or more ionic liquids. In a preferred embodiment, the sulfur and chlorine may be treated with trihexyl(tetradecyl)phosphonium cation.

In some embodiments of the invention, the solubilisation of the organic portion of the waste feed material may result in the generation of heavy metals (or compounds including heavy metals). In a preferred embodiment of the invention, heavy metals generated in the reaction vessel may be removed separately to the hydrocarbons.

The heavy metals may be removed from the reaction vessel using any suitable technique. For instance, the heavy metals may be captured or sequestered using a sorbent such as, but not limited to, zeolite and/or lime. In some embodiments of the invention, residual heavy metals may be filtered and treated by the algae ponds.

It is envisaged that some waste feed materials may contain fluorinated compounds and fluorinated pollutants (PFAS). In some embodiments of the invention, the waste feed material and/or the products of the method of the present invention may be subject to a PFAS removal process. The PFAS removal process may be performed in the reaction vessel. Preferably, the PFAS removal process will be performed separate from the treatment process.

The PFAS removal process may be performed using any suitable method. It is envisaged the PFAS may be removed using a substrate configured to absorb the PFAS. Any suitable substrate may be used such as but not limited to, carbonaceous substances (including activated carbon, biochar, and so on), ion exchange resins, or the like. Preferably the substrate may comprise a naturally occurring material such as a diatomaceous earth material or a clay.

The clay may be of any suitable form. For instance, the clay may be a modified clay such as, but not limited to, calcium rich montmorillonite (CaMT) and an alkyl chain. In a preferred embodiment, the modified clay may be an ionic liquid-modified clay, such as CaMTC16. It is envisaged that the modified clay may be modified to provide active surface moieties. Preferably the active surface moieties may be configured to catalyse a reaction, absorb one or more molecules or the like, or a combination thereof.

In another embodiment, the PFAS may be removed using an ion exchange resin. The exchange resins may be of any suitable composition, including but not limited to, anionic and non-ionic exchange resins containing polystyrene or quaternary amines, as examples.

In another embodiment, the PFAS may be removed using granular activated carbon (GAC).

Preferably, the PFAS may be removed using a membrane filtration process. In some embodiments the PFAS may be removed using a distillation process.

In some embodiments, the PFAS maybe hydrotreated to undergo defluorination to reduce the toxicity of the waste.

In some embodiments, the PFAS removal process will require dehydrochlorination.

It is envisaged that, at a first elevated temperature, a first portion of the organic material in the waste feed material may decompose and/or depolymerise to form hydrocarbons. In some embodiments of the invention, the hydrocarbons generated at the first elevated temperature may be removed from the reaction vessel prior to the temperature being changed to the second elevated temperature. Hydrocarbons generated at the second elevated temperature may then be removed from the reaction vessel prior to the temperature being changed to a third elevated temperature, and so on.

Hydrocarbons removed from the reaction vessel at one of the plurality of elevated temperatures may be used upon removal. Alternatively, hydrocarbons removed from the reaction vessel may be transferred to one or more storage vessels. In this embodiment of the invention, it is envisaged that hydrocarbons generated at each of the plurality of elevated temperatures may be collected in the one or more storage vessels prior to use. Thus, it is envisaged that all hydrocarbons generated by the processing of a batch of waste feed material may be collected in the one or more storage vessels. In some embodiments, hydrocarbons generated in the processing of two or more batches of waste feed material may be collected in the one or more storage vessels.

It is envisaged that hydrocarbons removed from the reaction vessel may be in the form of a gas, a liquid or a combination of the two. In embodiments of the invention in which at least a portion of the hydrocarbons are in the form of a gas, one or more condensers may be located between the reaction vessel and the one or more storage vessels in order to convert gaseous hydrocarbons to liquid form.

In embodiments of the invention in which at least a portion of the hydrocarbons are in the form of a liquid, the hydrocarbons may be extracted using an organic solvent in a liquid-liquid extraction process.

In an alternative embodiment of the invention, the hydrocarbons may be distilled to provide different fractions. The fractions may be collected to provide various types of fuel. It will be understood that the different fractions provide different compositions and such compositions may be used without refinement for application such as, but not limited to, bunker fuel, diesel, petrol, aviation fuel, and the like.

In some embodiments, an inorganic by-product may remain in the reaction vessel following the removal of hydrocarbons therefrom. The oil product separated from the reaction vessel is expected to contain some portion of one or more ionic liquids, solvents, and/or catalysts. In some embodiments the oil product may be washed using an appropriate solvent, such as, but not limited to, water, hexane, chloroform, or diethyl ether. The washing may then be used to recover one or more ionic liquids, solvents, and/or catalysts to be recharged and reused in the treatment process.

In some embodiments, the reaction vessel residue is treated to recover catalytic fluid. The catalytic fluid may be treated using any suitable method. In some embodiments, the catalytic fluid may be collected using a liquid-liquid extraction.

In some embodiments, the separation of the residual one or more ionic liquids and/or solvents from the oil product may be undertaken in a secondary treatment vessel.

The oil product may be used for any suitable purpose. In some embodiments of the invention, the oil product may be used in the fabrication of other materials (such as plastics or the like).

It is envisaged that at least a portion of the waste feed material may not be decomposed and/or depolymerised by the process. It is envisaged that this portion may be an inorganic portion of the waste feed material. Preferably, at the completion of the process of the present invention, the inorganic portion of the waste feed material may be removed from the reaction vessel. The inorganic portion may be recycled or otherwise disposed of.

It is envisaged that a portion of the organic portion of the waste feed material may not be decomposed or depolymerised in the process of the present invention. For instance, substances such as inert ash, waxes or bitumen may be produced. These substances may be removed from the reaction vessel and recycled, re-used (such as in road construction) or otherwise disposed of.

As previously discussed, hydrocarbons generated in the method of the present invention may be collected in one or more storage vessels. In some embodiments of the invention, the hydrocarbons (in gaseous or liquid form) may be combusted, and the energy generated by the combustion of the hydrocarbons may be used to heat one or more boilers. In turn, steam produced by the one or more boilers may be used to drive one or more turbines to generate electrical energy. Electrical energy used in this manner may be stored, used to drive the method of the present invention, or exported to a power grid.

In an alternative embodiment, the hydrocarbons (in gaseous or liquid form) and the carbon residue may be directly combusted to generate fuel for a combined heat power generator or the like.

In this embodiment of the invention, the waste gases generated by the combustion of the hydrocarbons may be transferred to a pond, such as an algae pond. Algae in the algae pond may consume carbon monoxide and carbon dioxide in the waste gases to generate oxygen. Oxygen generated in this manner may be captured or released to the atmosphere.

It is envisaged that algae from the algae pond may be periodically removed. Algae removed from the algae pond may be added to the waste feed material as part of the biomass portion or exported for external applications. In some embodiments, the collected algae may be used as a fertiliser.

### While described as a “pond”, it will be understood that the algae pond may comprise a pool, lake, dam, tank or any suitable vessel capable of holding water and algae.

In other embodiments of the invention the hydrocarbons generated in the reaction vessel may be transferred to a fractionating column. It is envisaged that the hydrocarbons may be separated into two or more hydrocarbon fractions in the fractionating column. The two or more hydrocarbon fractions may be used for any suitable purpose, such as vehicle fuel, heating fuel and so on.

Preferably, ionic liquids, nanoparticles and/or catalysts may be recovered from the reaction vessel. It is envisaged that the It is envisaged that the ionic liquids, nanoparticles and/or catalysts may be separated from the residual inorganic material in the reaction vessel using any suitable technique. For instance, ionic liquids, nanoparticles and/or catalysts may be separated by evaporation (and subsequent condensation), filtration or the like, or any suitable combination thereof. Alternatively, one or more solvents may be added to the medium to separate the desired residue from the inorganic material. The solvent (and the ionic liquids, nanoparticles and/or catalysts) may then be removed from the reaction vessel and separated.

Separation of the ionic liquids, nanoparticles and/or catalysts from the solvent may be achieved using any suitable technique. In a preferred embodiment of the invention, the combined solvent and ionic liquids, nanoparticles and/or catalysts may be heated to any suitable temperature. However, it is envisaged that the temperature may be between about 30° C. and 300° C. More preferably, the temperature may be between about 45° C. and 250° C. Most preferably, the temperature may be between about 60° C. and 200° C.

In some embodiments of the invention the ionic liquids, nanoparticles and/or catalysts may be separated from the solvent via rotary separation. Rotary separation may be performed in conjunction with, or instead of, the heating of the medium. Depending on the nature of the ionic liquids, nanoparticles and/or catalysts, the rotary separation may be performed in a magnetic or non-magnetic centrifuge.

Preferably, at least a portion of the separated ionic liquid, nanoparticles and/or catalysts may be recycled to the reaction vessel for re-use. In some embodiments of the invention, at least a portion of the catalysts may undergo a reactivation process prior to being recycled to the reaction vessel. The reactivation of the catalysts may be performed at any suitable location and using any suitable technique, although it is envisaged that the reactivation of the catalysts may be performed using heat or chemical reactivation. However, in a preferred embodiment of the invention, a process vessel in fluid communication with the reaction vessel may be used as the location for the reactivation of the catalysts. Thus, the reactivated catalysts may be returned to the reaction vessel from the process vessel following their reactivation.

The present invention provides numerous advantages over the prior art. Firstly, the ability to treat waste feed material with no or minimal any pre-treatment, such as the separation of biomass, polymeric and inorganic portions of the waste or primary extensive size reduction, represents a significant saving in time, energy and cost. In addition, treating waste feed material primarily in a single reaction vessel not only reduces equipment and operating costs, but also reduces the footprint (both physical and carbon) of the process.

In addition, the reuse of NCTF and solvent reduces ongoing costs, while the use of an algae pond serves to reduce carbon emissions and provide an additional source of biomass for the method.

Furthermore, the moderate conditions (low temperature and atmospheric or relatively low pressure) and minimal pretreatment requirements reduce manufacturing costs and assembly times, facilitating modular construction. It will be recognised that traditional methods of hydrocarbon production are performed on large scales to economise the process. The modular assembly of the present invention therefore provides a financially viable processing option for small scale operations.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a schematic view of a method for the conversion of waste according to an embodiment of the present invention.

### DETAILED DESCRIPTION

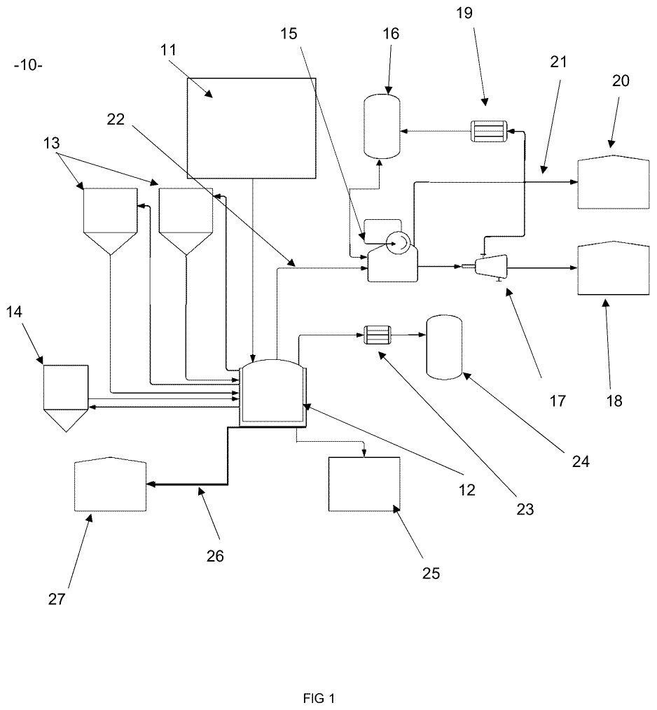

FIG. 1 illustrates a schematic view of a method 10 for the conversion of waste according to an embodiment of the present invention. waste feed material 11 is introduced to a reaction vessel 12 with minimal pre-sorting, classification or size reduction. An NCTF is also added to the reaction vessel 12 from holdings tanks 13. Finally, a solvent is added to the reaction vessel 12 from a solvent holding tank 14.

In this embodiment of the invention, the waste feed material 11 includes a biomass portion, such as food scraps, and paper and cardboard products. The waste feed material 11 also includes a polymeric portion comprising waste plastic and combined materials such as insulated electrical wires (being metal wiring having a polymeric coating). The waste feed material 11 also includes an inorganic portion comprising metal (such as the electrical wiring), ceramics and so on.

The NCTF used in the method 10 comprises a combination of substances. Specifically, the NCTF comprises a mixture of 1-butyl-3-methylimidazolium chloride-aluminium chloride and [Benz-SO3Him]+[HSO4]-. Additional catalysts in the form of SnPt/y-Al₂O₃, WOW/SiO₂ and/or zeolite are added to the ionic liquid.

It is envisaged that the 1-butyl-3-methylimidazolium chloride-aluminium chloride and [Benz-SO₃Him]⁺[HSO₄]⁻ may act as a catalyst to decompose or deconstruct the biomass portion of the waste feed material 11. Further, these catalysts may depolymerise at least a portion of the polymeric portion of the waste feed material 11, while SnPt/y-Al₂O₃, WOₓ/SiO₂ and/or zeolite are used to depolymerise a portion of the polymeric portion that is not depolymerised by 1-butyl-3-methylimidazolium chloride-aluminium chloride and [Benz-SO₃Him]⁺[HSO₄]⁻.

The solvent added from holding tank 14 is dimethyl sulfoxide (DMSO), although n-pentane and/or crude glycerol or similar may also form part of the solvent held in the storage tank 14.

The reaction vessel 12 is heated to a plurality of elevated temperatures in order to decompose or depolymerise the organic components of the waste feed material 11. The biomass portion of the waste feed material 11 typically decomposes at a lower temperature than the polymeric portion of the waste feed material 11 depolymerises, and so it is envisaged that the temperature of the reaction vessel 11 may be raised from a first elevated temperature (to decompose the biomass portion) to a second elevated temperature (to depolymerise the polymeric portion). The temperature may be raised continuously, or may be raised to the first elevated temperature, held at that temperature to decompose the biomass portion, and then raised to the second elevated temperature.

In a first stage, the temperature of the reaction vessel 12 may be raised to a first elevated temperature of between about 120° C. and 300° C. to decompose or deconstruct the biomass portion of the waste feed material 11. Preferably, the first elevated temperature is between about 200° C. and 280° C. The reaction vessel 12 may be maintained at the first elevated temperature for a period of time of between about 1 hour and 2 hours to ensure that the biomass portion of the waste feed material 11 is substantially fully decomposed or deconstructed. It will be understood that this time and/or the first elevated temperature may vary depending on the nature and proportion of the biomass portion of the waste feed material 11.

The decomposition or deconstruction of the biomass portion generates hydrocarbon gases 22. These hydrocarbon gases 22 may remain in the reaction vessel 12 until the completion of the method 10, or may be removed continuously, or at the completion of the decomposition or deconstructions of the biomass portion. The hydrocarbon gases 22 are flammable, and so are transferred from the reaction vessel 12 to a boiler 15 in which the hydrocarbon gases 22 are combusted. The heat generated by the combustion of the hydrocarbon gases 22 in the boiler 15 is used to convert water from water tank 16 into steam which, in turn, drives the operation of a turbine 17 to generate electricity. The electricity generated in FIG. 1 is exported to a power grid 18.

Steam used to drive the turbine 17 is condensed in condenser 19 and the condensed water is returned to water tank 16 to be reheated in the boiler 15.

Exhaust gases 21 from the boiler (at least a portion of which comprise carbon dioxide) are transferred to an algae pond 20. Preferably, the exhaust gases 21 are bubbled through the algae pond 20 such that algae in the algae pond consumes or absorbs the carbon dioxide (and carbon monoxide if present) and filters residual heavy metals. The product of this process is oxygen, which is released to the atmosphere.

At least a portion of the algae in the algae pond 20 is periodically removed (particularly as it grows or spreads) and the removed portion of the algae may be added to the waste feed material 11 as part of the biomass portion thereof.

Once the biomass portion of the waste feed material 11 is decomposed or deconstructed, the temperature of the reaction vessel 12 is raised to the second elevated temperature in order to depolymerise the polymeric portion of the waste feed material 11. The second elevated temperature is between about 250° C. and 310° C., and the reaction vessel 12 may be maintained at the second elevated temperature for between 1 hours and 4 hours. It will be understood that this time and/or the second elevated temperature may vary depending on the nature and proportion of the polymeric portion of the waste feed material 11.

As with the biomass portion, the depolymerisation of the polymeric portion of the waste feed material 11 generates hydrocarbon gases 22 that are removed from the reaction vessel 12 and treated in the same manner as the hydrocarbon gases 22 generated by the decomposition or deconstruction of the biomass portion.

Water vapour generated in the reaction vessel 12 is removed and condensed in a condenser 23 and stored in a water tank 24. Water in the water tank 24 may be used in the method 10, filtered in algae ponds 20, or may be used for other purposes.

In the embodiment of the invention illustrated in FIG. 1, at the completion of the depolymerisation of the polymeric portion of the waste feed material 11 and the removal of hydrocarbon gases 22, the reaction vessel 12 contains NCTF, inorganic material 26 from the waste feed material 11 and a residual material 25. The residual material 25 may comprise a mixture of long-chain (high molecular weight) hydrocarbons, such as bitumen or carbon residue. The residual material 25 may also contain inert ash, waxes and so on. The residual material 25 is removed from the reaction vessel 12, and may be used for road construction or any other suitable purpose.

The inorganic material 26 (metal and other inorganics) is removed from the reaction vessel 12 and transferred to a recycling centre 27 where suitable recyclable portions of the inorganic material 26 are recycled. Non-recyclable portions of the inorganic material 25 may be re-used or disposed of in any suitable manner.

The used NCTF and solvent in the reaction vessel 12 may be returned to the NCTF holding tanks 13 and the solvent holding tank 14, respectively. If necessary, the solvent and NCTF may be separated by heating the NCTF/solvent mixture in the reaction vessel and/or subjecting the NCTF/solvent mixture to separation in a rotary centrifuge (not illustrated).

Once separated, the solvent is returned to the solvent holding tank 14. The NCTF may be returned directly to the NCTF holding tanks 13, or may be reactivated using heat and/or chemical reactivation after which the NCTF is returned to the NCTF holdings tanks 13.

At the end of the method 10 as described, it is envisaged that the reaction vessel 12 is substantially empty. A new batch of waste feed material 11 is then added to the reaction vessel 12 and the method 10 is repeated.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for the conversion of waste, the method comprising the steps of:
Introducing a waste feed material to a reaction vessel, wherein at least a portion of the waste feed material comprises organic material, the organic material comprising a biomass portion and/or a polymeric portion;
Processing the waste feed material in the reaction vessel at an elevated temperature in the presence of a medium including one or more ionic liquids, one or more catalysts, and/or one or more solvents, the medium being configured to convert the organic material to one or more hydrocarbon compounds; and
Removing the one or more hydrocarbon compounds from the reaction vessel for use or for further processing.

2. The method according to claim 1, wherein the waste feed material comprises at least 10% w/w of the organic material.

3. The method according to claim 1 wherein the waste feed material is compacted or compressed prior to processing in the reaction vessel.

4. (canceled)

5. The method according to claim 1 wherein the medium is a nano catalyst treatment fluid comprising the one or more ionic liquids, a plurality of nanoparticles and/or one or more catalysts.

6. The method according to claim 5 wherein two or more ionic liquids are present in the nano catalyst treatment fluid.

7. The method according to claim 6 wherein the two or more ionic liquids comprise—butyl-3-methylimidazolium chloride-aluminium chloride and [Benz-SO₃Him]³⁰ [HSO4⁻].

8. (canceled)

9. The method according to claim 1 wherein the one or more ionic liquids catalyse the conversion of the organic material to the one or more hydrocarbon compounds.

10. The method according to claim 1 wherein the one or more ionic liquids function as a solvent.

11. (canceled)

12. The method according to claim 5 wherein the one or more catalysts comprise tandem dehydrogenation and olefin metathesis catalysts.

13. (canceled)

14. (canceled)

15. The method according to claim $1, wherein the one or more catalysts comprise Cu(5%)/TiO₂, or CaMTC16.

16. The method according to claim 5 wherein the plurality of nanoparticles comprise nanoparticles of tungsten, disulfidezinc oxide, silicon dioxide, diamond, clay, boron, boron nitride, silver, titanium dioxide, tungsten, γ-aluminium oxide, carbon or molybdenum disulfide.

17. A method according to claim 1 wherein the elevated temperature is between about 25° C. and about 400° C.

18. The method according to claim 1 wherein the elevated temperature is adjusted from a first temperature at which the biomass is decomposed or deconstructed, to a second temperature at which the polymeric materials are depolymerised.

19. (canceled)

20. (canceled)

21. (canceled)

22. (canceled)

23. (canceled)

24. The method according to claim 18 wherein the hydrocarbon compounds generated at the first temperature are removed from the reaction vessel prior to the temperature being adjusted to the second temperature.

25. A method according to claim 1 wherein the hydrocarbon compounds generated in the reaction vessel are used in the generation of electrical energy or fuel.

26. The method according to claim 25 wherein waste gases produced in the generation of electrical energy or fuel are transferred to an algae pond to consumer carbon dioxide and carbon monoxide in the waste gases and to generate oxygen.

27. The method according to claim 26 wherein at least a portion of the algae in the algae pond is periodically removed and added to the waste feed material.

28. The method according to claim 5 wherein the one or more ionic liquids, the plurality of nanoparticles and/or the one or more catalysts are separated from a residual inorganic portion of the waste feed material at the completion of the method.

29. The method according to claim 28 wherein the one or more ionic liquids, the plurality of nanoparticles and/or the one or more catalysts are separated from the residual inorganic portion of the waste feed material using one or more solvents.

30. (canceled)

31. (canceled)

32. (canceled)

33. (canceled)

34. (canceled)

35. (canceled)

36. The method according to claim 1 wherein the medium includes an ionic liquid-modified clay or GAC for treatment of fluorinated pollutants.
